(19) United States
(12) Patent Application Publication
(10) Pub. No.: US 2015/0356566 A1
(43) Pub. Date: Dec. 10, 2015

(54) SYSTEM AND METHOD FOR THE STORAGE OF DATA IN ASSOCIATION WITH FINANCIAL ACCOUNTS

(71) Applicant: INTELLECTUAL VENTURES I LLC, WILMINGTON, DE (US)

(72) Inventors: Mary C. Tennenbaum, Dallas, TX (US); David H. Tannenbaum, Dallas, TX (US)

(21) Appl. No.: 14/830,602

(22) Filed: Aug. 19, 2015

Related U.S. Application Data
(63) Continuation of application No. 11/767,246, filed on Jun. 22, 2007.
Application No. 11/767,246 is a continuation-in-part of application No. 10/192,426, filed on Jul. 10, 2002, now Pat. No. 7,254,548.

(51) Int. Cl. G06Q 20/40

(52) U.S. Cl. CPC G06Q 20/40145

(57) ABSTRACT

Systems and methods are established for data that is obtained auxiliary to but concurrent with a given transaction to be coordinated and stored in association with the transaction account data to which the transaction pertains. In one embodiment, the stored auxiliary data is provided to the user at the time the user views his/her account transactions. In another embodiment, the auxiliary information is provided to the user at the time of the transaction for authorization purposes. In a still further embodiment, the obtained auxiliary data is matched against prestored data to resolve questionable transactions. The provided data can be delivered via a phone call, email or over an Internet connection to the user.

### CROSS-REFERENCE TO RELATED APPLICATIONS

This application is a continuation-in-part of U.S. patent application Ser. No. 10/192,426, filed Jul. 10, 2002, entitled “SYSTEM AND METHOD FOR THE ADMINISTRATION OF FINANCIAL ACCOUNTS USING PROFILES”, the disclosure of which is hereby incorporated herein by reference thereto.

### TECHNICAL FIELD

This invention relates to network administration of financial transactions and more particularly to systems and methods for storing data obtained during a financial transaction in association with a user's file.

### BACKGROUND OF THE INVENTION

The popularity of credit cards, debit cards, automatic teller machine (ATM) cards and other facilities for financing and handling transactions for the consuming public is now without question. It is easy, and all too prevalent, that along with such popularity and ease of use of most point of sale credit facilities, comes financial difficulty for many people. This difficulty can arise because user's overextend themselves at the point of sale, or because someone fraudulently uses a credit facility or an ATM in an unauthorized manor.

Many credit facilities today allow consumer users to obtain current balances, as well as recent purchase information, by telephone or Internet, or other on-line access. Often this request is recorded by the credit management company. In other situations, user's obtain cash from ATM machines. It is common practice to take the picture of user's when they access their accounts from such access points. In the future it may even become accepted for a user accessing an account on-line from a computer or other terminal to provide voluntarily (or even non-voluntarily) a live digital image(s) of the user during the transaction.

This auxiliary data, whether it be audio recordings, digital images, video segments, biometric data, etc, is typically stored in a data base separate from user's actual account. For example, in the case of ATM transactions, the pictures are stored together with other pictures from that ATM machine and accessed only when a trouble condition occurs. The same is true of video surveillance data at a point of sale terminal. It is only when a problem occurs that the data base of video surveillance is accessed. This access is typically by using time stamps on the stored data (or in the database) and matching the stored images at a particular transaction time. This is useful when a major crime has been committed but is not practical to avoid fraud situations at the time of occurrence or to detect fraud situations by the user.

In some situations, users, particular with respect to ATM cash withdrawals, review their account activity and note that a cash withdrawal has been made on a particular date at a certain ATM machine. Memories being what they are, the user may not remember that transaction, or the transaction may have been made by a another trusted user. In either event, the person reviewing the transaction listing for that account has no immediate ability to verify the authenticity of the cash withdrawal.

Another problem exists today when some users have the use of a card issued to another person. For example, in an employer/employee situation often an employee is given use of a credit card for the purchase of goods or services which are business related. Sometimes a child or other trusted person is given a credit card to use. When such a “friendly” use occurs it is often difficult to know for sure that the credit facility is being used by the proper friendly user. When payment statements arrive listing all of the transaction occurring during a period of time it is also difficult to determine which person made a particular purchase or who conducted a particular financial transaction.

### BRIEF SUMMARY OF THE INVENTION

The present invention is directed to systems and methods which provide for data that is obtained auxiliary to but concurrent with a given transaction to be coordinated and stored in association with the transaction account data to which the transaction pertains. In one embodiment, the stored auxiliary data is provided to the user at the time the user views his/her account transactions. In another embodiment, the auxiliary information is provided to the user at the time of the transaction for authorization purposes. In a still further embodiment, the obtained auxiliary data is matched against prestored data to resolve questionable transactions. The provided data can be delivered via a phone call, email or over an Internet connection to the user.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a block diagram of one embodiment of my invention where the credit card user is making a purchase at a point of sale located at a merchant's premises;

FIG. 2 shows a block diagram of another embodiment of my invention where the credit card user is making a purchase, editing a profile or obtaining account information via an on-line Internet (or telephone) connection;

FIGS. 3A and 3B show one embodiment of the operation of my invention where the user obtains information from and/or edits his/her profile;

FIG. 4 shows one embodiment of my invention where the processing system, in response to a request, provides a message and/or blocks the transaction dependant, in part, upon the information contained in the user's profile;

FIGS. 5 and 6 show embodiments of profile data bases on a category by category basis;

FIG. 7 shows one embodiment of a user account organized by category;

FIGS. 8, 9 and 10 show embodiments of the invention where biometric information is obtained from a user during a financial transaction and stored in association with the transaction data;

FIGS. 11, 12 and 13 show embodiments of methods for storing and retrieving stored biometric data and for presenting retrieved data to the account user; and

FIG. 14 shows one embodiment of a method for using biometric data for resolving possible fraudulent transactions.

### DETAILED DESCRIPTION OF THE INVENTION

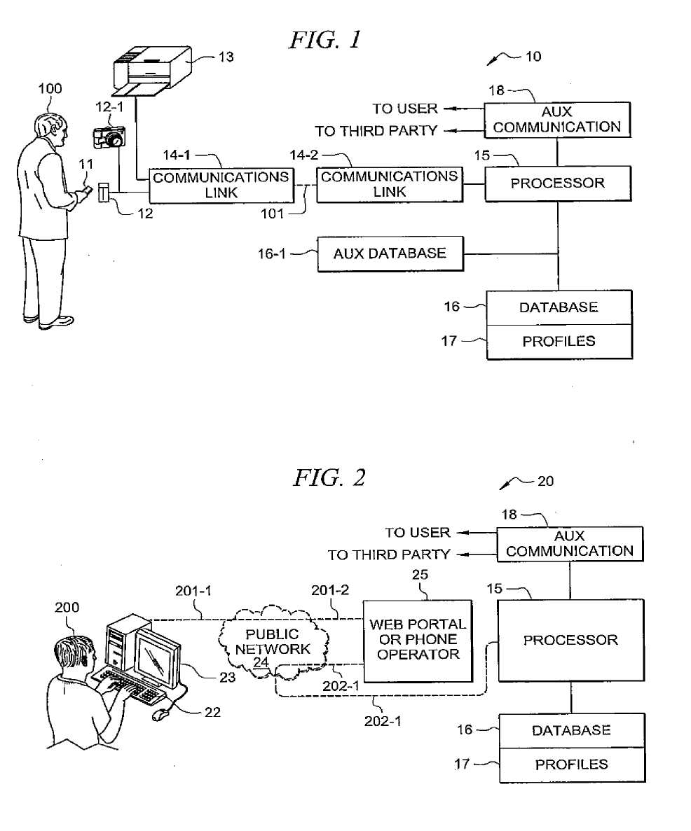

Turning now to FIG. 1, there is shown System 10, which is one embodiment showing user 100 with credit card 11, getting ready to insert the card into card reader 12 to complete a sales transaction at a point of sale. The information from card reader 12 is communicated via communications links 14.1 and 14.2 and network 101 to central processor 15. Processor 15, in conjunction with database 16 and profiles 17, then categorizes the various purchases being made and stores those purchase amounts and categories in database 16, according to profiles of user 17, as stored, for example, in profile data base 17.

As will be discussed, these profiles can include not only the budget amounts for each category, but what types of items would fit into the different categories. Based upon the profiles, processor 15 then can communicate in one or more of several way, such as, for example, back over communications links 14-1, 14-1 to user 100 or over alternate communication paths via auxiliary communication 18. This communication can be, for example, via printer 13, or it can be via auxiliary communication path 18. Auxiliary communication 18 can be, for example, to the user via cell phone, pager, or other device. At the same time, if desired, third parties, such as parents, employers, debt counselors and others, could also be notified. This communication can, if desired, occur for all purchases, or for certain of the purchases by category or by amount.

The system can be designed, if desired, such that if the amounts in a category (or if the total outstanding balance at that time) were to exceed a certain amount, user 100, or a third party as identified in the user's profile, would be required to give specific approval for a particular purchase. This system could be extended so that third parties (such as parents) can allow a child to use a credit card, but certain purchases over a certain amount, or all purchases, or purchases in certain categories, will require approval from the parent (or other third party), who would not actually be present at the point of sale.

For example, a parent could allow a child to have a credit card for the purpose of buying clothes. The child then selects his or her purchases at a location and runs card 11 through the card reader at the point of sale. The system, via profile 17, database 16 and processor 15, then recognizes that this is a card which is a sub-account card of a main account, or an account that is otherwise special to this person. Processor 15 then enables a communication to the third person identified by profile 17 via auxiliary communication 18. This communication could be, for example, cellular, landline, Internet, pager, PDA, or the like. The purchase can only be completed, if the third person responds in a positive manner (perhaps by pushing a button or speaking an acceptance word as set out in the user's profile). Processor 15, perhaps working in conjunction with other network processors, controls the acceptance back to the point of sale.

In some situations, it could be appropriate for the item that is being purchased to have a picture, available either in an auxiliary database 16-1, or transmitted from the point of sale at the time of purchase, transmitted to a third person, either for approval or simply for information purposes. This would be helpful, for example, when a husband is buying a suit and wants his wife to see the suit before the purchase is consummated. A picture of the suit could be captured by camera 12-1, communicated over the communication link to processor 15, and then through auxiliary communication 18 to a designated third party at a cell phone, computer, pager, PDA, or the like.

In some situations, the purchaser may desire additional information, such as warranties, specifications, pictures, assembly instructions, to be sent to a specific location (such as the point of sale, or to his/her home), or the purchaser may wish to register his/her purchase with the seller, or even apply for a rebate, all at the time or purchase. Processor 15, working in conjunction with database 16 and profiles 17 then could send the purchaser's address and other information to the seller. The seller's information obtained from transmitted POS information, or from data contained at the central location, such as from auxiliary database 16-1, would be combined with the user's (purchaser's) information as obtained from database 16, and sent to the seller. Since the user specific database contains information pertaining to the user's prior purchases it could be used, for example to aid the purchaser in making new purchases, perhaps by providing compatibility information to the user, either at the POS or on demand. This compatibility information could be within system 10, but would likely reside with each specific seller and could be supplied to the user at the POS (or on demand) in response to the above-discussed purchase registration.

Note that auxiliary database 16-1 can hold any type of information that is desired to be communicated to either user 100 or to third parties. This information could be sound, video, or any type of information, and can be stored in compressed format in the well-known manner. Also the information sent to a third party could be, for example, pictures, video, color, audio or any combination thereof. In addition, the information could be partially located in the database, such as database 16-1 and available based upon some information, perhaps a bar code or other information sent from card reader 12 or from camera 12-1.

In addition, the system could use camera 12-1 to take a live picture of user 100 at the point of sale and to then match that picture against a known picture or other information. This could then be sent to a third party for verification based upon a profile in database 17. Thus, when a main user of a credit card allows other sub-users, which could be employees, children, relatives, temporary workers, to use the sub-account card, each purchase using the sub-account card could trigger, if desired, the taking of a picture of the then user at the POS. This picture, or other information (such as a password) could be transmitted, under control of profile 17, database 16 and processor 15 to the main user, as discussed above, such that the transaction would not be completed until the main user signified acceptance.

This system, for example, could be used to keep an account “open” for the real user for a period of time when a card is reported lost or stolen. In such an event, the profile would be used to provide the system with a special verification procedure unique to the user. This verification could be for example, a password necessary at each purchase, or a biometric sent from the POS for comparison during each transaction.

System 10 could operate such that the main user, as will be discussed, can at any time change his/her profile, thereby adding or changing passwords, and assigning passwords or other control information to the profile. These passwords could be for the main account, or for any sub-account. When the credit card is presented at a POS, system 10 would check the user's profile to see if any such passwords, third party approvals, etc, are required. If so, the salesperson at the point of sale could then follow directions sent to that person via network 101 so as to obtain the proper identification of the user. This would give an added measure of security to credit card users. For example, the profile of a user might specify that call-in purchases (ones where the card is not physically present at the POS location) will need to be verified by a specified password, or verified by a communication placed by the salesperson (or by system 10) to a third person. The user's own created profile will allow for flexibility in this regard.

Note that the profile of the user, including database information if desired, could be stored on the user's card along with, if desired, at least some of the processing. In such a scenario, information from the profile would be sent to a central processing network to provide the services for the user as discussed above. A so called “smart card” would be one method of accomplishing this objective.

Turning now to FIG. 2, there is shown System 20 in which user 200 is utilizing keyboard 22 and computer 23 to access his or her account via communication links 201-1 and 210-2 and public network 24 to web portal or phone operator 25. Portal 25 then accesses processor 15 via communication link 202-1. Such accessing of the system by user 200 could be for the purpose of obtaining account information at any time on a category by category basis, or for establishing (as will be discussed) various account categories, balances and sub-users, or user 200 could be using computer 23 (which could be a telephone, pager, PDA, or the like) as a POS device. Note that connection 201-1, as well as the other connections shown, could also be by pager network, cellular network or any other type of network, including for example, wireless, wire line or the cable satellite network typically utilized for broadcast signals into the home for entertainment purposes. Once connected to processor 15, the system operates as discussed above with respect to FIG. 1. In the situation where at least a portion of the processing is on the user's smart card, then the user would insert his/her card at a reader (not shown) associated with computer 23. Of course, if the smart card included wireless technology, such a reader would be unnecessary, both in FIG. 2 as well as in FIG. 1.

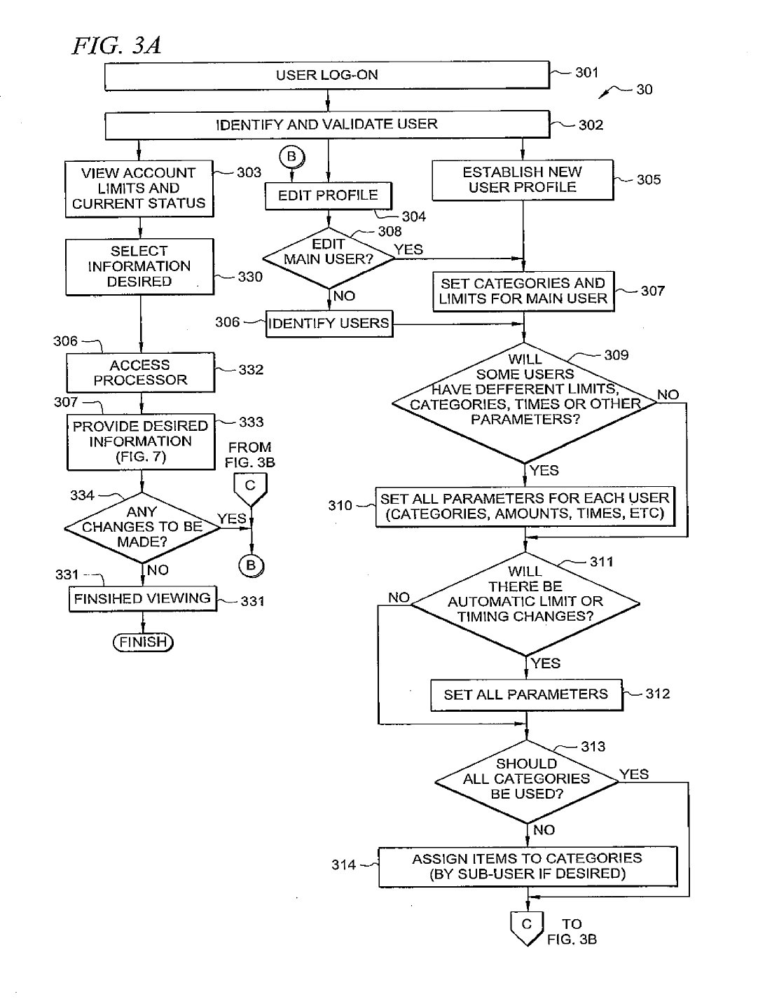

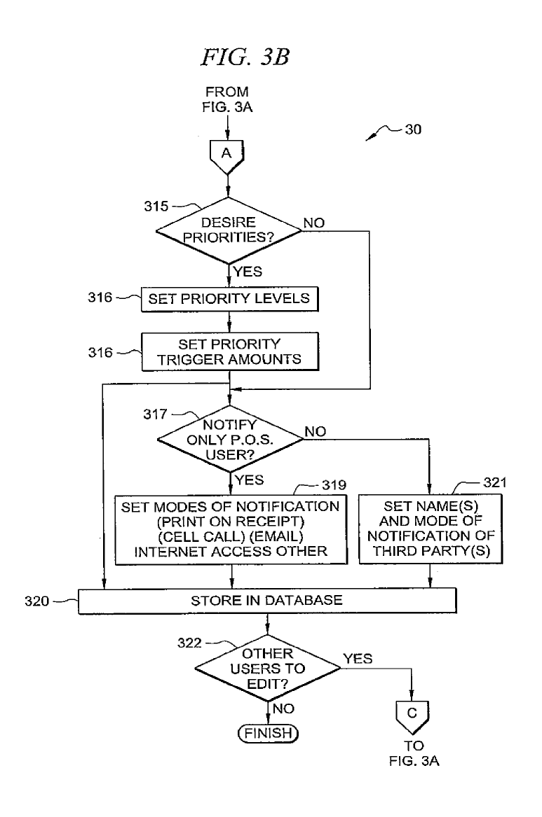

FIG. 3A shows system 30 which is one embodiment of a system utilized to enable system 10 (FIG. 1), or system 20 (FIG. 2) where a user can establish various categories and credit limits and/or view the existing account at any time. In process 301 the user logs onto the system as is well known. In process 302 the user is identified and is validated by the system. At this point the user is given several choices, three of which are shown in FIG. 3A. One such option, as shown in process 303, allows the user to view the account limits and current status. The user in process 304 could edit the profile and in process 305 the user may establish new profiles.

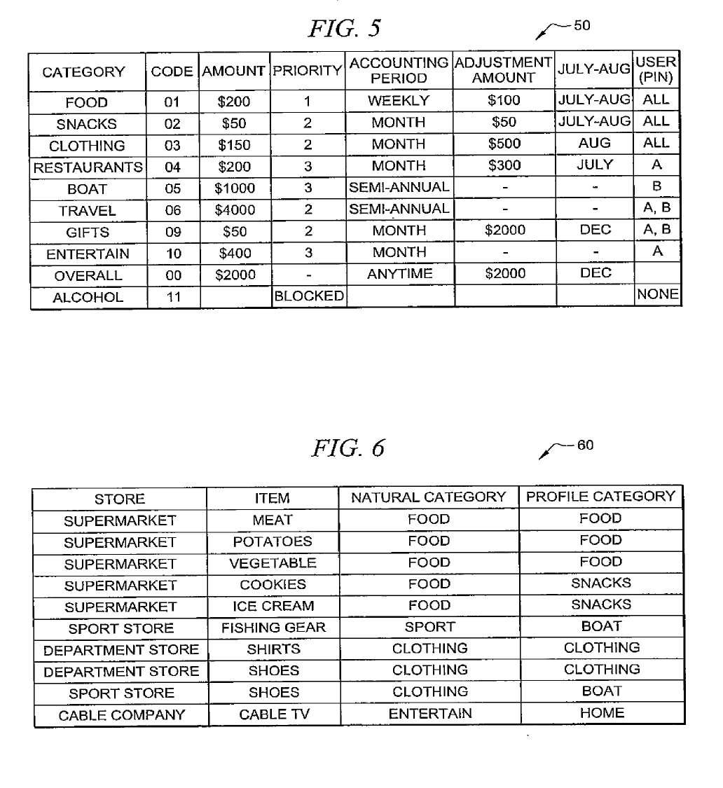

Assuming the user wanted to view the account limits, then the user in process 330 would select the desired information. The system in process 306 would access the processor and other databases and profiles to provide the desired information, via process 307, which could be in the form of FIG. 5, 6 or 7, or other profile information. If the user desired to just view the information, process 334, then when the user was finished, as shown by process 331, the connection would be terminated in a well known manner.

If changes were to be made, as controlled by process 334, then the user would be directed to edit profile process 304, and the user could either edit the main user or sub-users. Assuming the main user is to be edited, the user is directed to the same path as would be utilized if there was to be established a new profile via process 305, such that the user, under control of process 307 would set the categories and limits for the main user.

Going back to process 308, had the main user decided to edit some profile other than the main user's profile, then the users would be identified via process 306 and the paths then would be concurrent for both the sub-users and main user, such that process 309 would inquire as to whether some users would have different limits, categories, times or parameters.

If the answers was yes, then those parameters would be set for each user as to which category, amount, time or any other parameter desired for individual sub-users and the main user. If everybody were to have the same limits, then process 309 would skip to process 311 and the question would be answered as to whether there are automatic limits with timing changes to be applied. If there were, those parameters would be set via process 312. Process 312 would also control any other parameter that needed to be set, such as, by way of example, the user's home address, phone number, email address, auxiliary addresses (both physical and electronic), cell phone numbers. Pagers, PDA addresses, third party notifications, together with their respective contact information, passcodes, special limits.

After the user is finished entering all of the desired parameters, the question would be asked as to whether the normal categories of purchase goods were to be used. By this it is meant that some categories would be preset by the system itself, such that clothes being purchased would always go under the clothing category. However, if desired, a user could decide that clothes from certain stores, or certain types of clothing, such as sporting clothes, would go under a sporting category. The user could decide, for example, such that certain foods would go under a discretionary category other than food. This can be seen in FIG. 6 where the natural category for, say ice cream, would be food, but a user could switch the natural category to a profile category of snack, if desired. Likewise, fishing gear would have a normal category of sporting goods, whereas this user would have a profile category of boating. This would allow a user to more finely tailor his or her profile to be more accommodating of the user's needs. It would allow a fine tuning of budgeting and expenses on an ‘as you go’ basis.

In process 314, the user can assign items to categories and can do so by sub-user if desired, so that certain sub-users can have access to all categories, or some categories, and also what items are included in those subcategories. For example, a parent may allow a child a credit card for the purchase of food, and restrict the child from buying alcohol or cigarettes, if so desired. Or, the parent could allow the child to have a credit card for the purchase of gasoline for the family car, but other products sold at the service station would fall into a different category, either naturally or as a selection under the categories selected under process 314, such that only certain products such as gasoline could be purchased by certain users of the credit card.

Continuing on FIG. 3B, if the user desired to set priorities for different categories, process 315, such that as discussed above, based upon the priority level set in process 316, and the trigger amounts in 318, the user would be notified of different category levels such that the user is better able to maintain a strict budget when necessary. Since these limits are all self-imposed the user can determine, on a category by category basis, the difficulty and manner for overriding any “inhibiting” message.

In process 317 it is determined whether only the point of sale user is to be notified, and if so, how that notification is to be made via process 319. Notification can be printed on the receipt, or the notification can be by cellular phone call, email or other notification and can be contemporaneously with the transaction or thereafter. If third parties are to be notified, then the names of the third parties and mode of notification can be set via process 321, all of which would be stored in database 16 and profile 17 (FIG. 1) via process 320.

Before exiting the system, the user may wish to edit the profiles, perhaps to add other people or other categories, limits or the like. If so the system recycles back to process 304, FIG. 3A. If not, the user is finished with the profile.

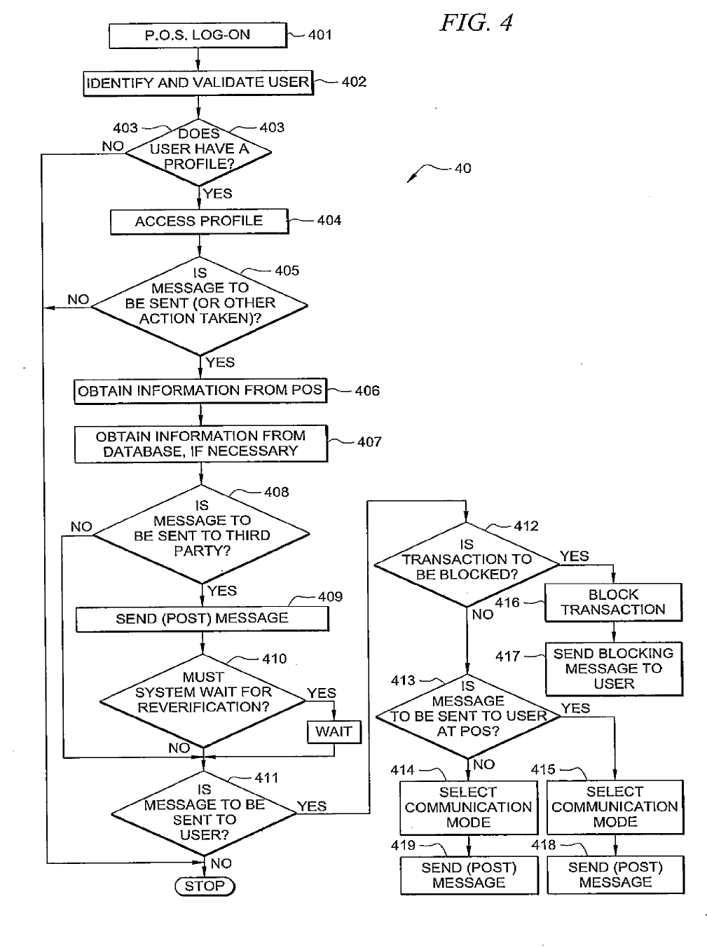

Turning now to FIG. 4, there is shown system 40 which illustrates one embodiment of the point of sale transaction where the user is in the process of buying a product using a credit facility. The user typically would have a card swiped through a reader, as discussed in FIG. 1. This operation is shown by processes 401 and 402. System 40 would then determine via process 403 whether the user has a profile. If not, the system would proceed as normal, in the well known manner.

If the user has a profile, then the profile is accessed via process 404 and the profile then begins to control the transaction at the point of sale. If there is not a message is to be sent to the user, or to a third party, and if no other special action is to be taken, then the system would proceed normally. If special POS actions are required, then the system would obtain any appropriate information from the point of sale via process 406. This information can be information from the specific transaction, such as items purchased, categories, amounts of each item. Or it could be information pertaining to the user, such as for example, a picture of the user, iris scan, fingerprint, or other biometric. In this case the picture (or other information) of the user would become an item to be stored and perhaps sent to third parties for verification of the transaction, or simply for record purposes. The information from the POS could be a user response, such as, for example, the mileage on a car. This information could then be used by the system to calculate the user's gas mileage (miles per gallon) based on “Gas” category purchases and user supplied information.

If necessary, process 407 would utilize POS information, such as bar codes or other category information, to then obtain other data from a data base. For example, based upon a bar code obtained from the POS, information could be sent back to the user at the POS or could be forwarded to one or more third parties, perhaps for verification, or for registration, or the like. Pictures of the purchased items could be obtained, along with specifications, warranty information, last minute updated information (such as usually contained in a Read Me file) and sent to the customer at the point of sale, if desired. If a message is to be sent to a third party via process 408, then this message is either sent or posted via process 409. Another example, would be for the system, based on profiled information, to send third party and address information back to the user, perhaps so that the user can send a purchase to the third party.

If the system must wait for verification from a third party, as contained in process 410, then process 420 controls this waiting period and the POS transaction stops until the desired information is returned. This information could be approval or other information from third parties, or it could be service contract information, specification information, or other types of information desired by a customer.

Then it is determined if a message is to be sent to the user. This message could be the overall account balance, or a category account balance, or if desired a summary of category balances. This information can be delivered before the completion of the transaction, or afterward, and it could be contained on a receipt generated at the POS or it could be a communication to a third party, all determined by the profile of the user.

Process 412 controls as to whether the transaction is to be inhibited in any manner. If it is, inhibiting (or blocking if desired) is controlled by processes 416 and 417. If it is not to be inhibited, a determination must be made if a message is to be sent to the user at the point of sale, or other places as controlled by processes 413, 414, 415, 418 and 419. If the transaction is to be inhibited, this is controlled by processes 416 and 417, all under pre-control of the user.

FIG. 5, as discussed above, shows different categories, codes for categories, amounts that the user has decided upon, the priority of the category, the accounting period for the priority, and how much the category can be adjusted and when the adjustment would occur.

For example, in the food category, the amount is $200.00 per week, but during the months of July and August, this is adjusted by $100.00 to take into account the different food intake needs of the family during vacation periods. In this case, all users have access. Code 4, which is restaurants, is a monthly account of $200.00 for eating out at restaurants. It is adjusted by $300.00 during the month of July, and the only user that can use it is the A user. The boat account is $1,000.00. It is a semi-annual amount and has a priority 3, which if desired, means that if other categories are over at a particular time when the boat account is to be used this account will be inhibited (subject to being overridden by the user) until the overall account balance goes below a certain amount.

As shown in the example, only the B user can buy purchases in the boat account. For this user account alcohol is a code inhibited for all users. Thus this account, regardless of who the user is, cannot buy alcohol because of the self-imposed prohibition. Of course, such prohibitions could apply to any category, such as tobacco, movies, etc., as established by the user of the account. These prohibitions can be on a category by category basis and can be more finely granulated so that sub-user accounts can each have different permission levels if desired.

FIG. 6 shows different natural categories that have been changed to the profile categories, depending upon the specific needs of this user. Thus, when the system processes purchases in certain natural categories, these categories are “translated” into the categories that the user desires. Thus, as discussed above, instead of ice cream being classified as a food, for this user, ice cream would be accounted of in the category called snacks.

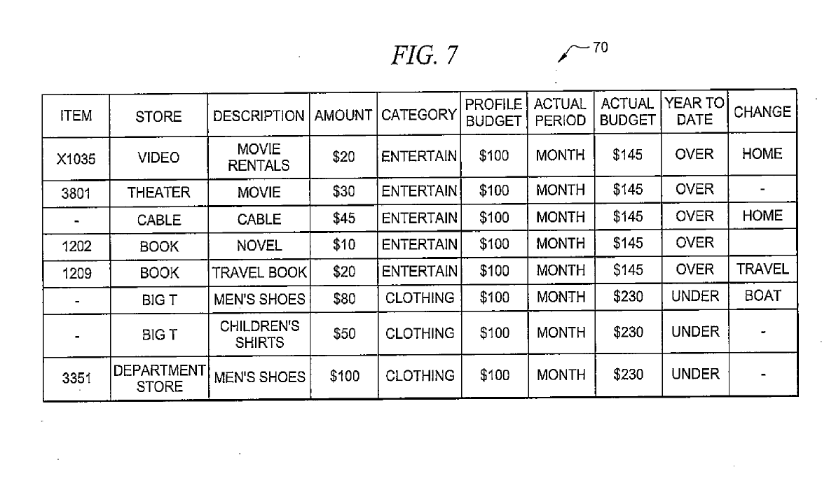

FIG. 7 shows a sample printout of information that is available to the user on demand of the user. This information can be periodically delivered to the user, or the user can obtain the information on-line via, for example, the Internet. The available information shows usage by category according to the specific profile of the user. This then allows the user to plan purchases and to know at any time where the user is with respect to the user's own budget. Of course, FIG. 7 can be arranged in any way and the information can be provided in different formats, and it even could be arranged as the user would like it to be, based upon user-designed formats.

It should be noted that while the example discussed above is an example using a credit card, the term credit facilitation system can be a credit card, a debit card, a smart card or even a card issued by a specific store, chain or organization for the purpose of providing discounts and/or identity for particular users.

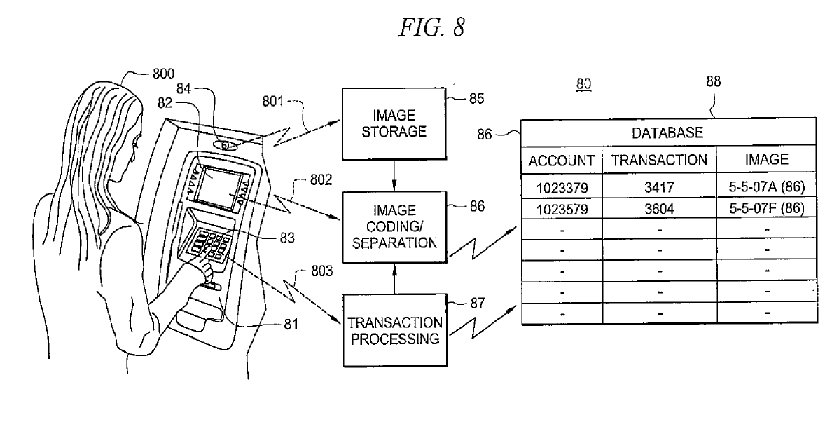

FIGS. 8, 9 and 10 show embodiments of the invention where biometric information is obtained from a user during a financial transaction and stored in association with the transaction data. For example, FIG. 8 shows embodiment 80 in which a user, such as user 800, is withdrawing funds from ATM 81 using keypad 83 or using any other cash transaction machine. During the transaction, camera 84 captures one or more pictures of user 800. These pictures ideally would be in digitized format when captured but if not they would then be converted to digital format by system 80. Note that while the example discusses digital images of the user, other biometrics could be obtained. For example, when the user touches the screen or the keypads, fingerprints can be obtained, or iris scans can be taken. The important point being, as will be discussed, that the captured biometric is stored in conjunction with the current transaction data and not simply stored in bulk in association with other captured biometric data.

Note that in the context of biometric data, the capture usually (but not always) occurs without being voluntary offered by the user. This is in contrast to transaction data, such as the account identification or the amount of the transaction, which the user voluntarily divulges. Also note that in most, but not all, of such “involuntary” data gathering scenarios, the data is gathered by a device which operates in common with many such transactions. For example, the security camera at an ATM is triggered by the transaction, or by the presence of a user, and is not normally keyed to the particular transaction. Thus, the resultant captured images are stored in bulk in a common data base (or on a reel of video tape) in common with all other transactions occurring between certain periods of time. Thus, when a problem occurs, someone must comb through the stored bulk file material using time references from the transaction(s) in question to find the captured biometric data.

Returning to FIG. 8, “involuntary” biometric data from camera 84 is, in this embodiment, communicated (wirelessly or by wire) via link 801 to bulk image storage 85. Voluntary transaction data from keypad 83 is passed from ATM 81 via link 803 to transaction processing system 87 as is well-known in the art. This transaction data is ultimately stored in database 88 for subsequent use. In the example discussed herein, transaction data from the keypad is also passed to image separation process 86 via link 802. Image storage 85, which can be a permanent storage or simply a temporary register, provides image data (or other gathered biometric data) to image coding/separation processing 86, which in turn works in conjunction with transaction processing 87. The result is that each transaction arriving from ATM 81 has associated therewith any biometric data obtained during the time of the transaction. This data is then stored in database 88 in association with the corresponding transaction data. Note that database 88 can contain the actual biometric data or could only have linking information to biometric data that is stored, for example, in image storage 85. By linking the stored biometric data and the transaction data, the biometric data can be used at a later date for verifying the validity of the transaction or for identifying a thief.

While ATM biometric data is discussed in this example, any biometric data that is captured concurrently with a transaction can be stored in association with the transaction data instead of, or in addition to, storage in bulk. For example, transaction data captured at a point of sale can have biometric data associated therewith. Also, when an entity (such as a person, vehicle, etc.) is required or otherwise identified and biometric data is captured in association with the identified entity, then the biometric data can be stored in association with the identified entity as well as in bulk, if desired.

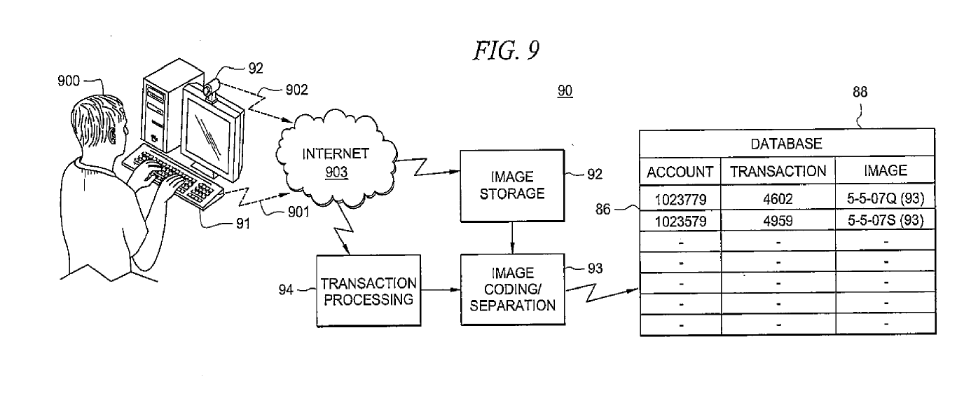

FIG. 9 shows embodiment 90 where user 900 at computer 91 completes transactions via Internet 901. During a transaction, camera 92 and/or the keypad or other′ biometric gathering devices, sends its captured data via link 902 to image storage 92. Transaction data is communicated via link 901 to transaction processing 94. Image coding/separation 93 then uses the transaction data to code the involuntary biometric data on a transaction by transaction basis for subsequent storage in database 88 in association with the concurrently generated transaction data. In this manner, as discussed above, the stored biometric data can be used at a later date for verifying the validity of the transaction.

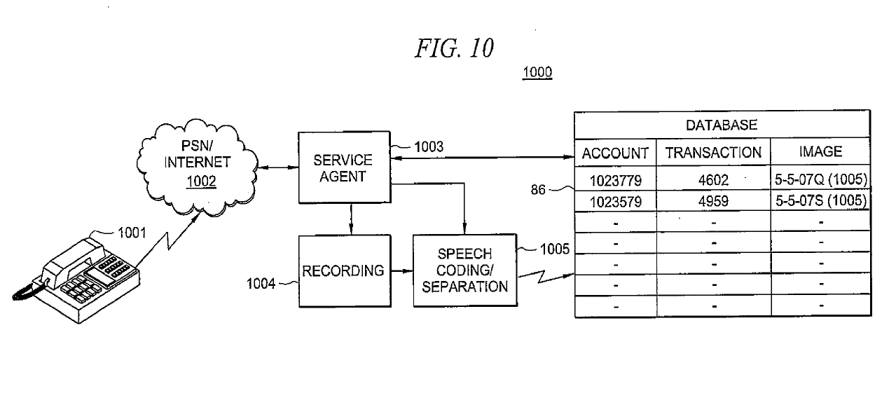

FIG. 10 shows embodiment 1000 in which a user at device 1001 accesses a service agent via PSN/Internet 1002. During this conversation, which can be audio or data, some portions of the conversation can be recorded or voiceprinted via recorder 1004. The recorded data then can be coded in conjunction with the transaction data and stored in database 88 in association with the transaction data. In this manner, the recorded data can be used at a later date for verifying the validity of the transaction.

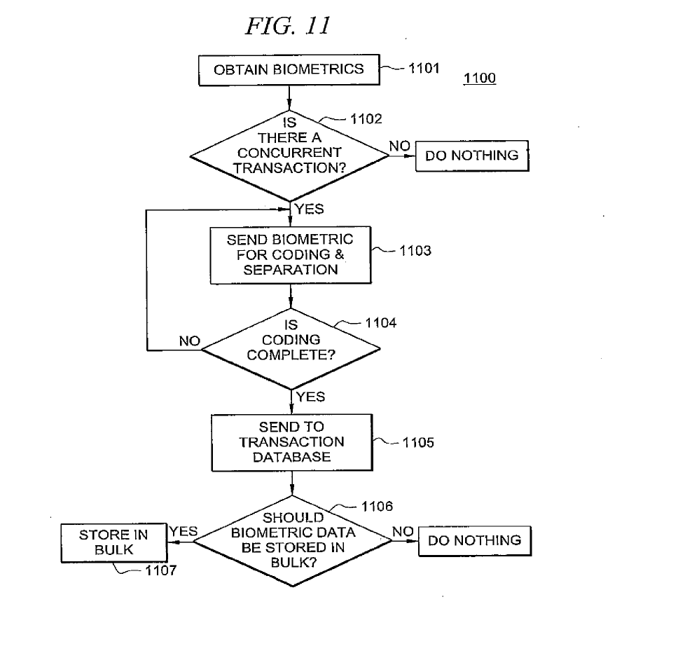

FIGS. 11, 12 and 13 show embodiments of methods for storing and retrieving biometric data and for presenting retrieved data to the account user. As shown in process 1100, FIG. 11, process 1101 obtains biometric data from a user during the course of a transaction. Process 1102 determines if there is a transaction occurring at the same time as the captured biometric data. If so, then the captured biometric data is coded, via process 1103, to match up with the concurrent transaction. When process 1104 determines that coding is complete, the captured biometric data (or a portion thereof) is stored (or linked) in a database in association with a particular transaction via process 1105. Process 1106 determines if biometric data is also to be stored at another location, or at the source of the captured data. If so, storage is controlled by process 1107.

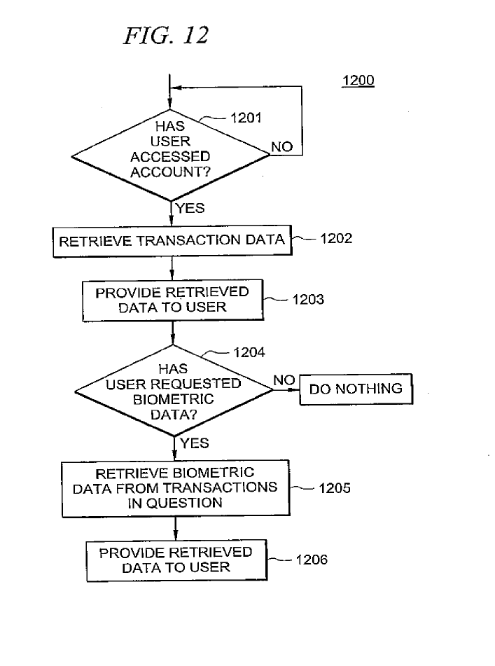

FIG. 12 shows one embodiment of a process, such as process 1200, in which process 1201 determines if a user has accessed a particular account. If so, the process 1202 retrieves transaction data, for example from database 88 (FIG. 8), from the account as requested by the user. Process 1203 provides the retrieved data to the user. The user, after viewing the transaction data, can request all, or certain, biometric data assuming that such data had not already been supplied to the user. Process 1204 handles such a request and process 1205 retrieves the biometric data, either by removing that data directly from the database, such as from database 88 (FIG. 8) or by using a link from that data base identifying the desired biometric data in another database. Process 1206 then provides the retrieved biometric data to the user.

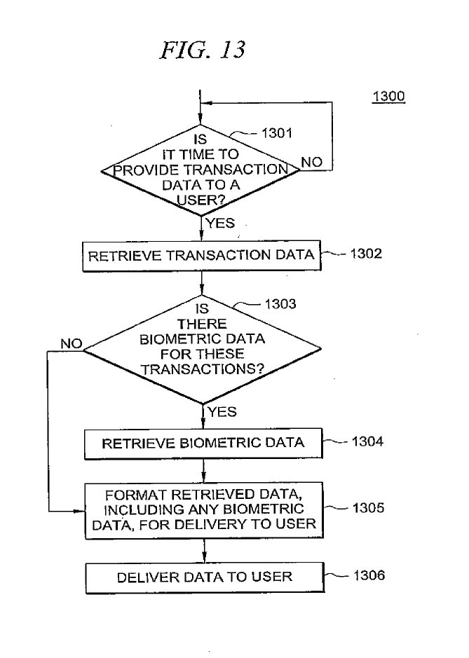

FIG. 13 shows one embodiment of a process, such as process 1300, in which process 1301 determines if it is time (perhaps on a periodic basis or upon request from a user) to provide transaction data to the user. If so, process 1302 retrieves transaction data, for example, from database 88 (FIG. 8). Process 1303 determines if there is biometric data for the retrieved transactions. If so, the biometric data is retrieved and provided to process 1305 for formatting for delivery to the user. Process 1306 delivers the retrieved and formatted data to the user.

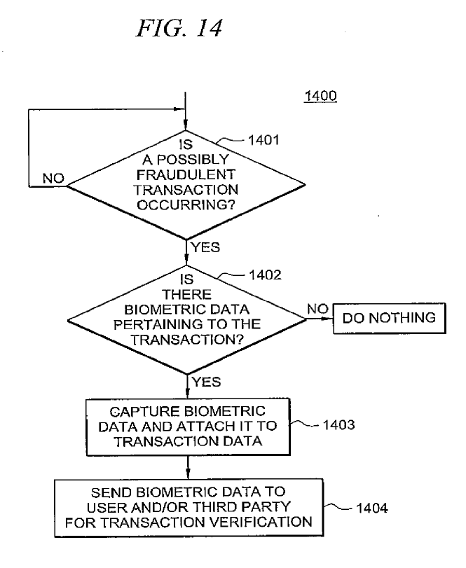

FIG. 14 shows one embodiment, such as embodiment 1400, in which process 1401 determines if a possible fraudulent transaction is occurring. The determination of a possible fraud situation can be based on a current transaction, or on past transactions. If a fraud situation is suspected, then process 1402 determines if there is biometric data being generated concurrently with the current transaction. If so, then process 1403 causes such biometric data to be captured and attached to the transaction data that is also concurrently being generated. Note that the detection of a possible fraud situation could trigger the capturing of biometric data. Process 1404 then uses the biometric data to resolve any ambiguity involving the current transaction. For example, the biometric data can be sent to the user's account manager at a bank or credit card company for verification as to the authenticity of the transaction. If desired, the biometric data can be sent to the user or compared to data previously stored by the user as part of a stored profile. This then allows currently generated biometric data, including video, audio, fingerprint, iris scans, etc., to be used to verify validity of the transaction in real time. In some situations, the system can make the comparison itself, based on previously stored data. This automatic determination can be by an automated fingerprint match or by image comparison, or other such comparison techniques.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-21. (canceled)

22. A payment processing system comprising:
a memory configured to store a pending transaction database and a transaction account database; and
a processor configured to:
receive account identity data from a point of sale terminal in connection with a pending transaction;
receive biometric data pertaining to a user associated with a transaction account associated with the point of sale terminal;
store the pending transaction and the biometric data in the pending transaction database, wherein the pending transaction is associated with the biometric data;
verify the account identity data and the biometric data with data in the transaction account database corresponding to the account identity data;
identify a user defined purchase category associated with an item of the pending transaction based on types of items that the user of the transaction account has assigned to the user defined purchase category; and
communicate a purchase amount of the item, a spending limit associated with the user defined purchase category, and the user defined purchase category to a third party prior to completion of the pending transaction.

23. The system of claim 22, wherein the third party includes an account manager.

24. The system of claim 22, wherein the processor is configured to communicate at least a part of a request for the third party to approve the pending transaction.

25. The system of claim 24, wherein the processor is further configured to communicate information to the third party based on a user profile maintained by a credit facilitation system.

26. The system of claim 25, wherein the processor is further configured to communicate data to be included in the user profile.

27. The system of claim 22, wherein the processor is further configured to communicate the purchase amount, the spending limit associated with the at least one user defined purchase category, and the at least one user defined purchase category to an entity designated to review one or more transactions corresponding to the account identity data, wherein the entity is separate from the third party.

28. The system of claim 22, wherein the processor is configured to receive the biometric data obtained from a camera associated with the point of sale terminal.

29. The system of claim 22, the processor is configured to receive the biometric data obtained from a camera that is common to a plurality of independent transactions pertaining to different users.

30. The system of claim 22, the processor is further configured to, in response to determining that completion of the pending transaction would result in the spending limit associated with the user defined purchase category being exceeded, transmit a notification to the user of the point of sale terminal.

31. A payment processing system comprising:
a memory configured to store data describing user accounts;
a processor configured to:
receive information from a point of sale (POS) terminal over a communication network, the information comprising a transaction account code presented for the payment associated with the transaction at the POS terminal;
based at least in part on the received information, identify a sub-transaction account of an account to charge the sub-transaction account for payment associated with a transaction, the received information;
based at least in part on the transaction account code, process the transaction in cooperation with a third party, wherein the third party receives an authorization request for the payment associated with the transaction at the POS terminal, and wherein the third party authorizes the payment of the transaction at the POS terminal;
retrieve account authenticating information corresponding to one or more POS actions designated in a profile associated with and controlled by an owner of the account; and
selectively enable the transaction based, at least in part, on the retrieved account authenticating information corresponding to the one or more POS actions designated in the profile associated with and controlled by an owner of the account.

32. The system of claim 31, wherein the transaction account comprises a bar code.

33. The system of claim 31, wherein the processor is further configured to:
confirm fund availability for the payment of the transaction based on a transaction account limit and a sub-transaction account limit, wherein the sub-transaction account limit is not greater than the transaction account limit, and wherein the payment is not greater than the sub-transaction account limit; and
transmit a textual notification of the availability of funds.

34. The system of claim 31, wherein the processor is further configured to block the transaction in response to a message from the third party indicative of denial of approval for the transaction.

35. The system of claim 31, wherein the processor is further configured to:
determine that approval for the transaction is required based upon the profile, the profile stored in association with the account in the memory; and
request approval from the third party responsive to the determination that approval for the transaction is required.

36. The system of claim 31, wherein the processor is further configured to communicate a request for approval to the third party.

37. The system of claim 36, wherein the processor is further configured to request approval based at least in part on account authenticating information corresponding to the one or more POS actions to enable the third party to confirm an identity of a user of a transaction instrument used for the transaction.

38. The system of claim 37, wherein the account authenticating information to enable the third party to visually confirm the identity of the user of the transaction instrument comprises an identification image of the user obtained via the POS terminal.

39. The system of claim 37, wherein the account authenticating information to enable the third party to confirm the identity of the user of the transaction instrument comprises biometric data corresponding to the user obtained via the POS terminal.

40. The system of claim 35, wherein the processor is further configured to request approval based at least in part on an account authenticating information corresponding to the one or more POS actions to describe the transaction to the third party including one or more of: seller information, product descriptions, an amount for the transaction, categories associated with the transaction, or product images.

41. The system of claim 35, wherein the processor is further configured to request approval using a message sent to the third party via one or more of: a cellular network, the Internet, a telephone network, a pager network, a broadcast network, a cable network, or a satellite network.
